(19) United States
(12) Patent Application Publication
(10) Pub. No.: US 2025/0296360 A1
(43) Pub. Date: Sep. 25, 2025

(54) IMAGE FORMING SYSTEM

(71) Applicant: Keita ACHI, Kanagawa (JP)

(72) Inventor: Keita ACHI, Kanagawa (JP)

(73) Assignee: Ricoh Company, Ltd., Tokyo (JP)

(21) Appl. No.: 19/085,018

(22) Filed: Mar. 20, 2025

(30) Foreign Application Priority Data
Mar. 22, 2024 (JP) 2024-046952
Sep. 5, 2024 (JP) 2024-153241

(51) Int. Cl. B41J 11/00; B41J 2/045; B41J 2/21

(52) U.S. Cl. CPC B41J 11/00216; B41J 2/04563; B41J 2/04573; B41J 2/04586; B41J 2/2114

(57) ABSTRACT

An image forming system includes a coater, an image former, a dryer, and circuitry. The coater coats a recording medium with a treatment liquid. The coater includes a supply pan, a heater, and a detector to detect a temperature of the treatment liquid. The circuitry, before controlling the image former to start the print operation, controls the coater to start a first preparation operation at a first start timing and complete the first preparation operation at a first completion timing, controls the dryer to start a second preparation operation at a second start timing and complete the second preparation operation at a second completion timing, and changes the second start timing of the dryer according to the temperature of the treatment liquid detected by the detector of the coater to match the second completion timing of the dryer with the first completion timing of the coater.

### CROSS-REFERENCE TO RELATED APPLICATIONS

This patent application is based on and claims priority pursuant to 35 U.S.C. § 119(a) to Japanese Patent Applications Nos. 2024-046952, filed on Mar. 22, 2024, and 2024-153241, filed on Sep. 5, 2024, in the Japan Patent Office, the entire disclosure of each of which is hereby incorporated by reference herein.

### BACKGROUND

### Technical Field

Embodiments of the present disclosure relate to an image forming system.

### Related Art

An image forming system is known that includes a coater (liquid coating apparatus) to apply a pretreatment liquid to a recording medium, an image former (image forming apparatus) that applies a liquid to perform printing, and a dryer (drying apparatus) to dry the recording medium to which the liquid has been applied.

In an image forming system including multiple units, each of the units performs a print preparation operation individually before printing is started, and the print operation is started after the print preparation operations of all the units are completed.

However, since the time required for completing the print preparation operation differs among the multiple units, a standby time is generated in some of the units until the print preparation operation is completed in all the units.

A technology has been disclosed that matches a timing at which multiple units complete the print preparation operation with a timing at which a unit that requires the longest time to complete the print preparation operation, thus creates a bottleneck, to reduce power consumption.

### SUMMARY

In an embodiment of the present disclosure, an image forming system includes a coater, an image former, a dryer, and circuitry. The coater coats a recording medium with a treatment liquid. The coater includes a supply pan to store the treatment liquid, a heater to heat the treatment liquid in the supply pan, and a detector to detect a temperature of the treatment liquid in the supply pan. The image former forms an image on the recording medium coated with the treatment liquid by the coater to perform a print operation. The dryer dries the recording medium on which the image is formed by the image former. The circuitry, before controlling the image former to start the print operation, controls the coater to start a first preparation operation at a first start timing and complete the first preparation operation at a first completion timing, controls the dryer to start a second preparation operation at a second start timing and complete the second preparation operation at a second completion timing, and changes the second start timing of the dryer according to the temperature of the treatment liquid detected by the detector of the coater to match the second completion timing of the dryer with the first completion timing of the coater.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an image forming system;

FIG. 2 is a diagram illustrating a coating module provided for a coater;

FIG. 3 is a side view of a heater;

FIG. 4 is a timing chart of a print preparation operation of an image forming system according to a comparative example;

FIG. 5 is a timing chart of a print preparation operation of an image forming system according to another comparative example;

FIG. 6 is a timing chart of a print preparation operation of an image forming system according to an embodiment of the present disclosure;

FIG. 7 is a graph illustrating a liquid temperature adjustment operation of a coater;

FIG. 8 is another timing chart of a print preparation operation of an image forming system according to an embodiment of the present disclosure;

FIG. 9 is a plan view of a head module of a discharger provided for the image forming system of FIG. 1;

FIG. 10 is a block diagram illustrating functional units of the controller; and

FIGS. 11A and 11B are diagrams each illustrating a case in which a timing at which a coater completes the print preparation operation and a timing at which a dryer completes the print preparation operation, match with each other.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given of an image forming system according to an embodiment of the present disclosure, with reference to the drawings. Embodiments of the present disclosure are not limited to embodiments described below, and changes such as other embodiments, additions, modifications, and deletions may be made within the scope conceivable by those skilled in the art. Any aspects are included in the scope of the present disclosure as long as the actions and effects of the present disclosure are exhibited.

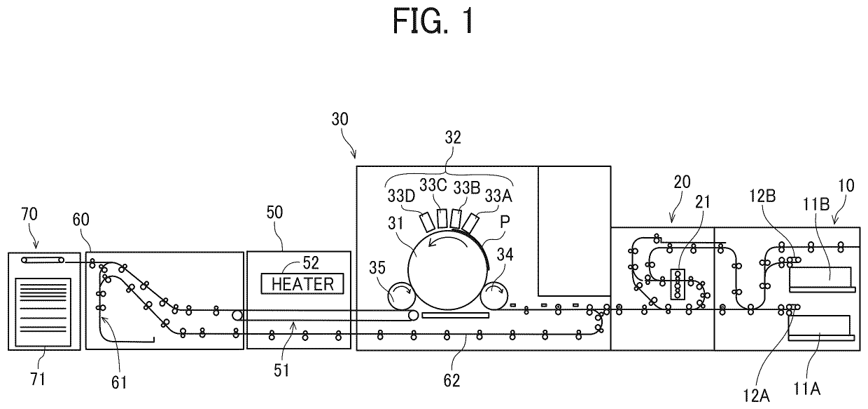

FIG. 1 is a schematic diagram illustrating an image forming system according to an embodiment of the present disclosure. The image forming system of FIG. 1 is an inkjet printing apparatus.

The image forming system of the present embodiment includes a sheet feeder 10 to convey a sheet P as a recording medium, a coater 20 as a pretreatment device, an image former 30 as an image former, a dryer 50 as a dryer, a reversing device 60 as a reverse mechanism, and a sheet ejector 70 as a sheet stacker.

In the printing system of the present embodiment, the coater 20 coats a treatment liquid (pretreatment liquid) onto a sheet P, which is conveyed (supplied) from the sheet feeder 10, as needed, and the image former 30 applies desired liquid to the sheet P to form an image.

Next, the sheet P on which the image has been formed is conveyed to the dryer 50, and the liquid that is applied is dried. Subsequently, the sheet P is ejected to the sheet ejector 70 as is via a reversing device, or after printing is performed on both sides of the sheet P.

### Sheet Feeder

The sheet feeder 10 includes a lower sheet tray 11A, an upper sheet tray 11B, and sheet feeders 12A and 12B. The lower sheet tray 11A and the upper sheet tray 11B accommodate multiple sheet P, and the sheet feeders 12A and 12B separate and feed the sheet P one by one from the lower sheet tray 11A or the upper sheet tray 11B. The sheet feeder 10 supplies the sheet P to the coater 20.

### Coater

The coater 20 as a pretreatment device includes, for example, a coating module 21 which is a treatment liquid application unit to apply the treatment liquid to a print surface of the sheet P.

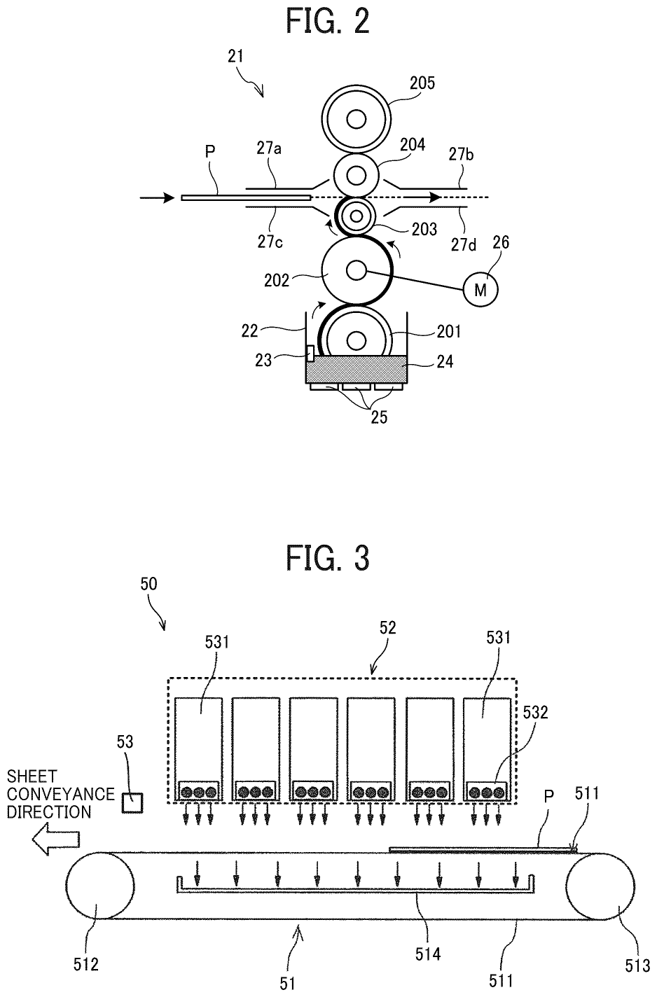

FIG. 2 is a diagram illustrating the coating module 21 provided for the coater 20.

The coating module 21 includes multiple rollers parallel to the axial direction, and each of the rollers is held such that the shaft is rotatable inside the housing of the coating module 21.

The coating module 21 includes a draw-up roller 201 as a first roller, a metering roller 202 as a second roller, a coating roller 203 as a third roller, a pressure roller 204 as a fourth roller, and a pressure roller 205 as a fifth roller.

The coating roller 203 and the pressure roller 204 have small diameters to prevent a thin paper from winding around the coating roller 203 and being jammed. The metering roller 202 and the pressure roller 205 that have high rigidity are disposed at positions sandwiching the coating roller 203 and the pressure roller 204.

The draw-up roller 201 is held by a supply pan 22, and the supply pan 22 is filled with a treatment liquid 24. The treatment liquid 24 is supplied from a tank to the supply pan 22.

While the draw-up roller 201, the metering roller 202, the coating roller 203, the pressure roller 204, and the pressure roller 205 contact each other, all of the above-described rollers are simultaneously rotated by the driving of a roller drive motor 26. The treatment liquid 24 that is drawn up by the draw-up roller 201 is transferred to the surface of the coating roller 203 via the metering roller 202.

Between the coating roller 203 and the pressure roller 204, an inlet upper guide 27a, an outlet upper guide 27b, an inlet lower guide 27c, and an outlet lower guide 27d that serve as a part of a conveyance path of the sheet P are disposed.

The sheet P passes through between the inlet upper guide 27a and the inlet lower guide 27c. Subsequently, the sheet P passes through a nip formed by the coating roller 203 and the pressure roller 204, and is conveyed through between the outlet upper guide 27b and the outlet lower guide 27d.

When the sheet P passes through the nip, one side of the sheet P is pressed against the surface of the coating roller 203 holding the treatment liquid 24, and the treatment liquid 24 is transferred to the sheet P.

The supply pan 22 includes a heater 25 to heat the treatment liquid 24 and a liquid temperature detector 23 to detect the temperature of the treatment liquid 24.

When the temperature of the treatment liquid 24 detected by the liquid temperature detector 23 is lower than a predetermined temperature, the heater 25 heats the treatment liquid 24.

In the present embodiment, the heater 25 is a nichrome wire heater, and the liquid temperature detector 23 is a thermistor.

### Image Former

The image former 30 includes a drum 31 and a liquid discharger 32. The drum 31 is a bearer (rotator) and rotates while bearing the sheet P on the circumferential surface of the drum 31. The liquid discharger 32 discharges liquid toward the sheet P borne on the drum 31.

The image former 30 further includes a transfer cylinder 34 and a transfer cylinder 35. The transfer cylinder 34 receives the sheet P sent from the coater 20 and transfers the sheet P to the drum 31, and the transfer cylinder 35 receives the sheet P conveyed by the drum 31 and transfers the sheet P to the dryer 50.

A leading end of the sheet P that is conveyed from the coater 20 to the image former 30 is gripped by a sheet gripper disposed on the transfer cylinder 34, and the sheet P is conveyed in accordance with the rotation of the transfer cylinder 34. The sheet P that is conveyed by the transfer cylinder 34 is transferred to the drum 31 at a position of the transfer cylinder 34 facing the drum 31.

A sheet gripper is also disposed on the surface of the drum 31, and the leading end of the sheet P is gripped by the sheet gripper. The drum 31 includes multiple suction holes dispersedly formed on the circumferential surface of the drum 31, and a suction unit generates suction airflows directed inward of the drum 31 from the suction holes of the drum 31.

On the drum 31, the sheet gripper grips the leading end of the sheet P forwarded from the transfer cylinder 34, and the sheet P is attracted to and borne on the drum 31 by suction airflows by the suction unit. As the drum 31 rotates, the sheet P is conveyed.

The liquid discharger 32 includes discharge units 33A, 33B, 33C, and 33D to discharge liquids. For example, the discharge unit 33A discharges cyan (C) ink, the discharge unit 33B discharges magenta (M) ink, the discharge unit 33C discharges yellow (Y) ink, and the discharge unit 33D discharges black (K) ink. In addition, it is also possible to use a discharge unit that discharges special ink such as white ink or gold (silver) ink.

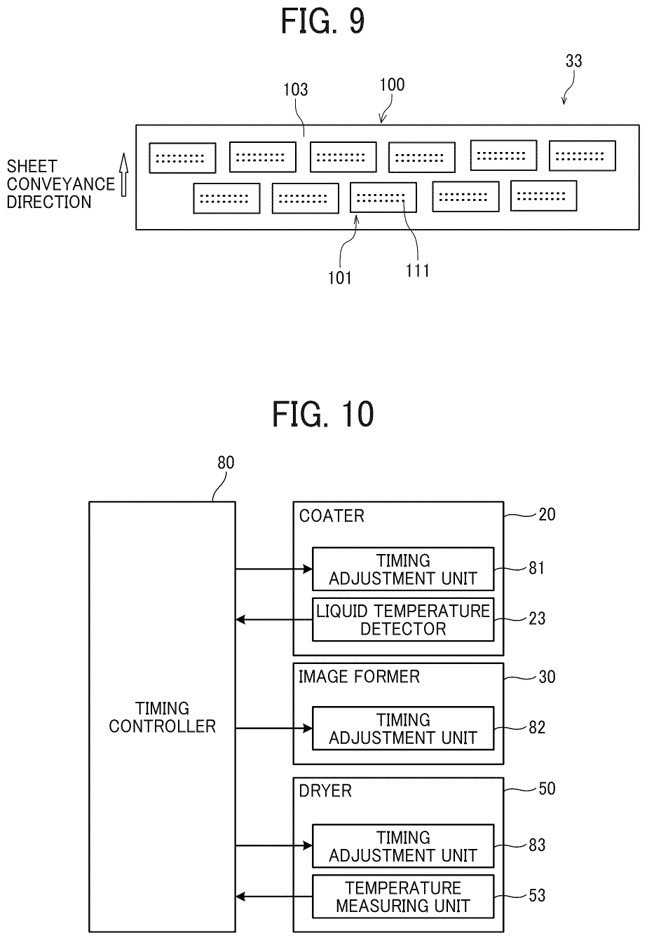

Each of the discharge units 33A, 33B, 33C, and 33D includes, for example as illustrated in FIG. 9, a head module 100 as a full-line head. The head module 100 includes multiple liquid discharge heads 101 arranged in a staggered manner on a base 103. Each of the liquid discharge heads 101 includes multiple nozzle rows in which multiple nozzles 111 are arranged. The liquid discharge head 101 may also be referred to simply as a “head 101”. The discharge operation of the discharge units 33A, 33B, 33C, and 33D of the liquid discharger 32 is controlled by drive signals corresponding to print data. When the sheet P that is borne on the drum 31 passes through an area facing the liquid discharger 32, the inks of the respective colors are discharged from the discharge units 33A, 33B, 33C, and 33D, and an image corresponding to the print data is formed.

### Dryer

The dryer 50 includes a heater 52 and a conveyor 51. The heater 52 heats and dries the sheet P conveyed by the conveyor 51 without contacting the sheet P.

FIG. 3 is a side view of the dryer 50.

The conveyor 51 includes a conveyance belt 511 that is an endless conveyance member that bears and conveys the sheet P. The conveyance belt 511 is wound around a drive roller 512 and a driven roller 513 and moves in a circumferential direction. As illustrated in FIG. 1, the conveyor 51 conveys the sheet P from the image former 30 to the reversing device 60.

The conveyance belt 511 has multiple openings suctioned by a suction chamber 514, which is a suction mechanism disposed inside the loop of conveyance belt 511. The conveyance belt 511 may be, for example, a mesh belt, a plain weave belt having suction holes. The suction chamber 514 includes, for example, a suction blower, a fan to suck the air through the multiple openings in the conveyance belt 511. The conveyor, i.e., the conveyance belt 511, is not limited to the conveyor that uses suction method to attract and convey the sheet P as described above. The conveyor may attract and convey the sheet P on the conveyor by, for example, an electrostatic absorption method or a gripping method using a gripper.

The heater 52 includes multiple heat irradiators 532 in corresponding one of multiple housings 531. In the present embodiment, the heat irradiator 532 is an infrared (IR) heater.

The dryer 50 also includes a temperature measuring device 53 for measuring the temperature in the dryer 50. In the present embodiment, the temperature measuring device 53 is a radiation thermometer capable of measuring the temperature of the conveyance belt 511 in a non-contact manner.

### Reversing Device

The reversing device 60 includes a reversing unit 61 and a duplex conveyance unit 62. The reversing unit 61 reverses the sheet P in a switchback manner when performing duplex printing on the sheet P. The duplex conveyance unit 62 feeds the reversed sheet P back upstream from the transfer cylinder 34 of the image former 30.

### Sheet Ejector

The sheet ejector 70 includes an output tray 71 on which multiple sheets P are stacked. The sheets P that are conveyed from the reversing device 60 is sequentially stacked and held on the output tray 71.

Examples of the sheet P include a sheet material such as a cut sheet material, a continuous body, which may also be referred to simply as a web, such as a continuous sheet, a roll sheet, and a wallpaper.

### Print Preparation Operation

The image forming system of the present embodiment includes the coater 20 for coating the sheet P with the treatment liquid, the image former 30 for forming an image on the sheet P, the dryer 50 to dry the sheet P, and a controller. The controller controls start and completion timings of print preparation operation performed by the coater 20, the image former 30, and the dryer 50 and matches timings at which the coater 20, the image former 30, and the dryer 50 completes the print preparation operation.

### Printing Preparation Operation of Coater

The print preparation operation of the coater 20 includes a supply operation of the treatment liquid 24, an adjustment operation to adjust the liquid temperature of the treatment liquid 24, which may also be referred to simply as a liquid temperature adjustment operation in the following description, and a cleaning operation.

The supply operation is an operation of supplying the treatment liquid 24 from the tank to the supply pan 22.

The liquid temperature adjustment operation is an operation of heating the treatment liquid 24 by the heater 25 when the temperature of the treatment liquid 24 detected by the liquid temperature detector 23 is lower than a predetermined value.

Typically, the viscosity of the treatment liquid (pretreatment liquid) 24 for performing pretreatment on the sheet P increases in a low-temperature environment. The coating module 21 has a characteristic in which the amount of liquid applied to the sheet P increases as the viscosity of the treatment liquid 24 increases. Applying the treatment liquid 24 excessively to the sheet P causes image defects. For this reason, the liquid temperature adjustment operation is performed as the print preparation operation. By so doing, the viscosity of the treatment liquid 24 can be prevented from increasing and the coating module 21 can apply an appropriate amount of the treatment liquid 24.

After the liquid temperature adjustment operation is completed, the cleaning operation is performed. The cleaning operation is an operation in which the draw-up roller 201, the metering roller 202, the coating roller 203, the pressure roller 204, and the pressure roller 205 of the coating module 21 rotate for a predetermined time to circulate the treatment liquid 24 on the surface of the coating roller 203. The rotation of the draw-up roller 201, the metering roller 202, the coating roller 203, the pressure roller 204, and the pressure roller 205 causes the treatment liquid 24 in the supply pan 22 to be moved to the surface of the coating roller 203, and the treatment liquid 24 that has been used and adhering to the surface of the coating roller 203 is removed.

The time necessary for the completion of the supply operation and the time necessary for the completion of the cleaning operation are not affected by the environmental conditions of the coater 20.

By contrast, the liquid temperature adjustment operation is affected by the environmental conditions of the coater 20, and the time necessary for the liquid temperature adjustment operation to be completed varies. For example, when the treatment liquid 24 is heated, the lower the ambient temperature, the longer the time necessary to complete the liquid temperature adjustment operation. As a result, the time necessary to complete the print preparation operation of the coater 20 is longer.

### Print Preparation Operation of Dryer

The print preparation operation of the dryer 50 includes a preheating operation.

The preheating operation is an operation of raising the temperature inside the dryer 50 to a predetermined temperature, and particularly an operation of raising the temperature of the conveyance belt 511 which the sheet P contacts to a predetermined temperature.

When the conveyance belt 511 is not sufficiently heated by the preheating operation, the temperature of the sheet P in contact with the conveyance belt 511 is lowered, and an image defect called a halftone dot may occur.

In the present embodiment, the heater 52 includes an IR heater as the heat irradiator 532. The IR heater directly irradiates energy from the IR heater, thus has a high heating efficiency. By contrast, the IR heater is inferior in responsiveness from a timing at which the IR heater is turned on to a timing at which the IR heater starts heating. For this reason, the turn-off and the turn-on again of the IR heater are not performed during the preheating operation. Accordingly, even when the inside of the dryer 50, i.e., the conveyance belt 511, reaches the predetermined temperature during the preheating operation, the heating is continued.

The time necessary for the completion of the preheating operation is slightly affected by the environmental conditions of the dryer 50. However, the influence can be ignored because the temperature set as the target temperature is extremely higher than the typical ambient temperature. Accordingly, the time until the completion of the print preparation operation of the dryer 50 can be set as a fixed value.

### Print Preparation Operation of Image Former

The print preparation operation of the image former 30 includes a cleaning operation of the liquid discharge head 101 and an operation of adjusting the temperature of ink which is liquid to be discharged.

The time until the print preparation operation of the image former 30 can be set as a fixed value.

### Timing Adjustment of Print Preparation Operation

The printing preparation operation of the coater 20 has more steps than the printing preparation operation of the dryer 50, and the heater 25 provided for coater 20 has a lower output than the heater 52 of the dryer 50. Accordingly, the time necessary for the coater 20 to complete the print preparation operation is longer than the time necessary for the dryer 50 to complete the print preparation operation.

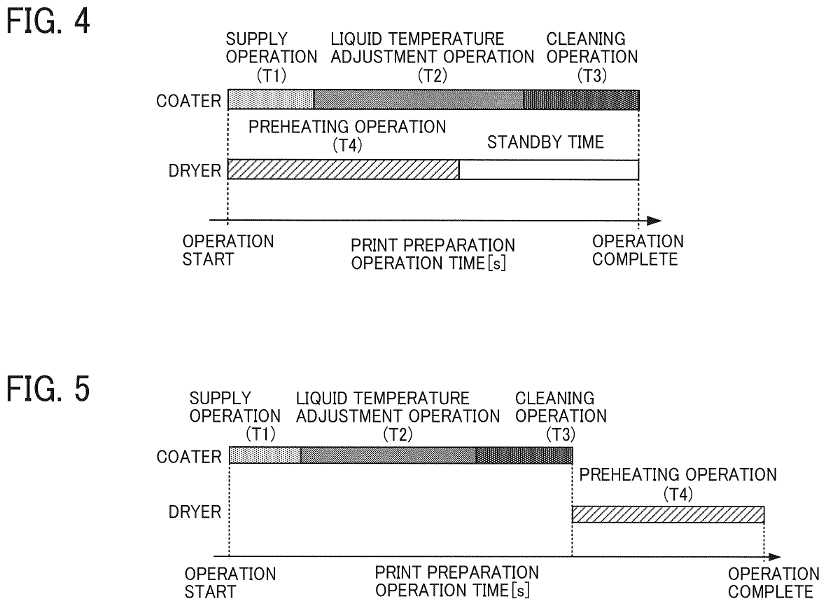

As illustrated in a timing chart of a comparative example of FIG. 4, when the print preparation operation of the coater 20 and the print preparation operation of the dryer 50 are started at a similar timing, the print preparation operation of the dryer 50 is completed first. Subsequently, a standby time of the dryer 50 occurs.

After the start of the preheating operation of the dryer 50, the IR heater included in the heater 52 is not turned off. Thus, the IR heater performs heating even during the standby time. Accordingly, the conveyance belt 511 is excessively heated, and the sheet P that contacts the conveyance belt 110 is damaged, for example, burned or waved.

By contrast, as illustrated in a timing chart of the comparative example of FIG. 5, when the print preparation operation of the dryer 50 is started after the print preparation operation of the coater 20 is completed, the time until the print preparation operations of both of the coater 20 and the dryer 50 are completed is long. Accordingly, the waiting time until the start of the printing operation is longer, which leads to deterioration in user convenience and operability.

By contrast, the image forming system of the present embodiment changes the timing at which the dryer 50 starts the print preparation operation in accordance with the detection result of the liquid temperature detector 23 of the coater 20, and matches the timing at which the dryer 50 completes the print preparation operation with the timing at which the coater 20 completes the print preparation operation.

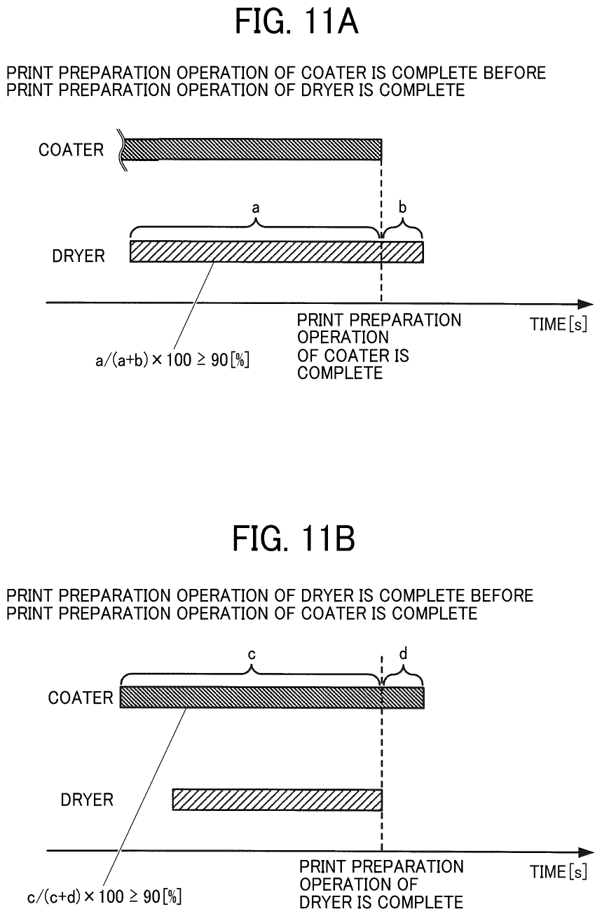

In embodiments of the present disclosure, “matching of the timings” is not limited to a perfect match, and may include some margin. Specifically, the print preparation operation is typically completed with some margin. Accordingly, when the print preparation operation is completed in about 90% of the time until the completion of the print preparation operation, a defective image is not substantially generated. For this reason, when 90% or greater of one of the print preparation operations is completed (90% or greater of the time of the print preparation operation has elapsed) at the timing when the other one of the print preparation operations is completed also corresponds to the above-described “matching of the timings” in embodiments of the present disclosure. This is also described below with reference to FIGS. 11A and 11B.

In other words, in the image forming system according to embodiments of the present disclosure, the controller changes the timing at which the dryer 50 starts the print preparation operation in accordance with the detection result of the liquid temperature detector of the coater 20. Also, the controller sets the time of one of the print preparation operations performed by the coater 20 and the dryer 50 to the completion to elapse 90% or greater at a timing at which any of the print preparation operations is completed earlier than the other one, between the timing at which the dryer 50 completes the print preparation operation and the timing at which the coater 20 completes the print preparation operation. The above-described case is also the “matching of the timings” in embodiments of the present disclosure.

A specific time that is included in the “matching of the timings” may include a slight range. Even if the timing at which the print preparation operation of the dryer 50 is completed exceeds the timing at which the print preparation operation of the coater 20 is completed by about 10 seconds, the conveyance belt 511 is not excessively heated, and even if the short circuit occurs, for example, the drying failure does not occur. Accordingly, a case in which the difference between the timings at which the print preparation operations of the dryer 50 and the coater 20 are completed is within +10 seconds may also be regarded as the “matching of the timings”.

In other words, in the image forming system of another embodiment of the present disclosure, the controller changes the timing at which the dryer 50 starts the print preparation operation in accordance with the detection result of the liquid temperature detector 23 of the coater 20, and sets a time lag between the timing at which the dryer 50 completes the print preparation operation and the timing at which the coater 20 completes the print preparation operation, to be within +10 seconds.

The above-described case is also the “matching of the timings” in embodiments of the present disclosure.

There is a preferable range for the specific times included in the “matching of the timings”. The time necessary for the sheet P to reach the dryer 50 is longer than the time necessary for the sheet P to reach the coater 20. Accordingly, the timing at which the dryer 50 completes the print preparation operation can be delayed to some extent with respect to the timing at which the coater 20 completes the print preparation operation.

In view of these, a preferable range of the specific time included in the “matching of the timings” can be defined, for example, as follows.

In other words, preferably that the time lag between the timing at which the dryer 50 completes the print preparation operation and the timing at which the coater 20 completes the print preparation operation is equal to or greater than −3 seconds or equal to or smaller than +10 seconds, when the timing at which the coater 20 completes the print preparation operation is set as a reference timing (0 second). Such a setting can also prevent unnecessary heating corresponding to the time of conveying the sheet P from the coater 20 to the dryer 50.

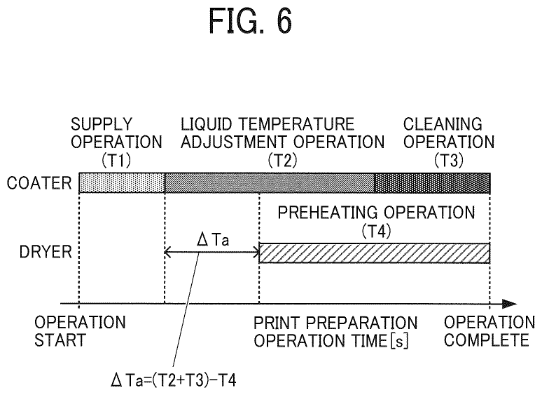

FIG. 6 is a timing chart of a print preparation operation of the image forming system of the present embodiment.

In the image forming system of the present embodiment, the controller estimates the timings at which the coater 20 and the dryer 50 complete the print preparation operation and matches the timing at which the coater 20 completes the print preparation operation with the timing at which the dryer 50 completes the print preparation operation. By so doing, the image forming system can prevent the sheet P from being damaged due to the print preparation operation and reduce the time necessary to perform the entire print preparation operation.

Specifically, the controller estimates a time period for the coater 20 to complete the print preparation operation based on the temperature of the treatment liquid 24 detected by the liquid temperature detector 23, and determines the timing at which the dryer 50 starts the print preparation operation based on the time period.

The start trigger Δ Ta of the pre-heating operation of the dryer 50 can be obtained by a formula: Δ Ta=(T2+T3)−T4, where T2 is the liquid temperature adjustment operation time of the coater 20, T3 is the cleaning operation time, and T4 is the pre-heating operation time of the dryer 50.

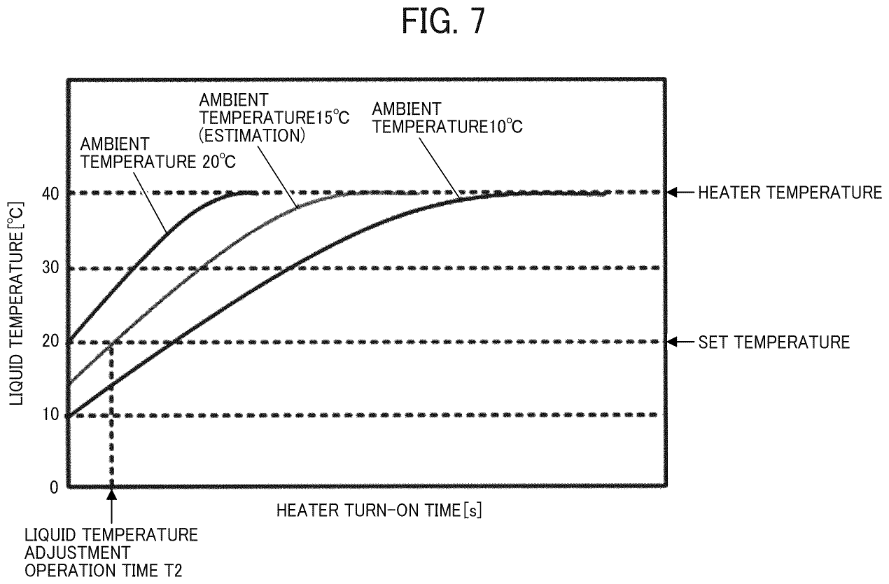

FIG. 7 is a graph illustrating the liquid temperature adjustment operation of the coater 20.

The time T2 necessary for the liquid temperature adjustment operation varies depending on the ambient temperature.

For example, when the temperature of the treatment liquid 24 held in the supply pan 22 is increased from 10° C. to 20° C. under the condition of the ambient temperature of 10° C., and when the temperature of the treatment liquid 24 is increased from 20° C. to 30° C. under the condition of the ambient temperature of 20° C., the former time is longer due to the influence of heat radiation.

For this reason, the correlation between the time in which the heater 25 is turned on and the liquid temperature rise for each of the ambient temperatures in FIG. 7 was measured, to grasp the correlation between the heater turn-on time and the liquid temperature of the treatment liquid 24 as illustrated in the graph of FIG. 7. The grasped correlation is stored in the controller in the form of, for example, a table. By so doing, the time necessary to complete the liquid temperature adjustment operation can be estimated.

FIG. 7 illustrates an example in which a heater capable of heating the treatment liquid 24° C. to 40° C. is installed as the heater 25, and the liquid temperature adjustment time when the treatment liquid 24 is heated to 20° C. under the condition of the ambient temperature of 15° C. is calculated.

As illustrated in FIG. 7, the curve of the ambient temperature 15° C. is estimated, and the liquid temperature adjustment time T2 can be calculated based on the estimated curve.

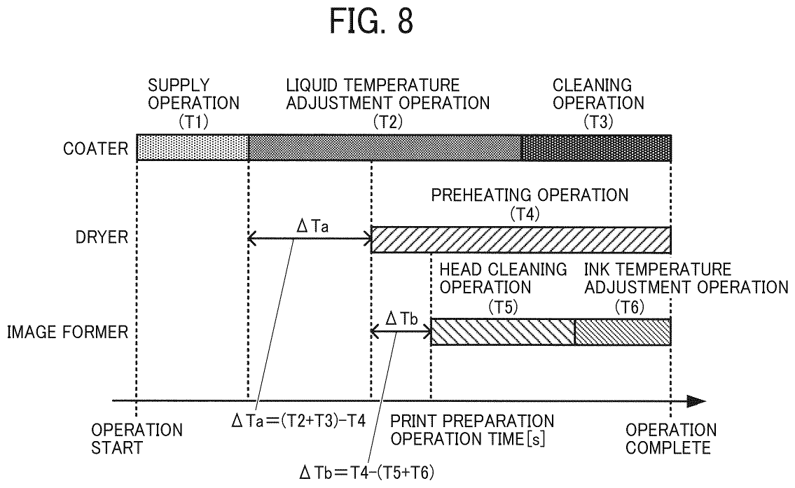

FIG. 8 is another timing chart of a print preparation operation of the image forming system of the present embodiment.

The image forming system of the present embodiment further estimates the timings at which the image former 30 and the dryer 50 completes the print preparation operation, and matches the timings at which the image former 30 and the dryer 50 completes the print preparation operation with each other.

Specifically, in the image forming system of the present embodiment, the controller estimates the timing at which the dryer 50 starts the print preparation operation in accordance with the detection result of the temperature measuring device 53 of the dryer 50, and matches the timing at which the dryer 50 completes the print preparation operation with the timing at which the image former 30 completes the print preparation operation.

The timing of the print preparation operation performed by the image former 30 is a fixed value that does not vary depending on the environmental conditions.

The start trigger Δ Ta of the pre-heating operation of the dryer 50 can be obtained by a formula: Δ Ta=(T2+T3)−T4, similar to the example of FIG. 6.

The start trigger Δ Tb of the pre-heating operation of the image former 30 can be obtained by a formula: Δ Tb=T5−(T6+T4), where the head cleaning operation time of the image former 30 is T5 and the ink temperature adjustment operation time is T6.

FIG. 10 is a block diagram illustrating functional units of the controller to control the timings at which the print preparation operation is started and completed, provided for the image forming system of the present embodiment.

The controller includes a timing controller 80 and timing adjustment units 81, 82, and 83 provided for the coater 20, the image former 30, and the dryer 50, respectively.

The timing adjustment units 81, 82, and 83 are units capable of controlling the timing at which the print preparation operation is performed.

The timing controller 80 determines start timings of the print preparation operation as illustrated in FIGS. 6 and 8 in accordance with the inputs from the liquid temperature detector 23 and the temperature measuring device 53, and controls the timing adjustment units 81, 82, and 83 of the coater 20, the image former 30, and the dryer 50, respectively.

FIGS. 11A and 11B are diagrams each illustrating a case in which the timing at which the coater 20 completes the print preparation operation and the timing at which the dryer 50 completes the print preparation operation, coincide with each other. As described above, there may be a case in which the time of one of the print preparation operations performed by the coater 20 and the dryer 50 to the completion elapses 90% or greater at a timing at which any of the print preparation operations is completed earlier than the other one, between the timing at which the dryer 50 completes the print preparation operation and the timing at which the coater 20 completes the print preparation operation. Such a case also is included in the “matching of the timings” in embodiments of the present disclosure. In this case, either the print preparation operation of the coater 20 or the print preparation operation of the dryer 50 may be completed first.

FIG. 11A is a diagram illustrating a case in which the print preparation operation of the coater 20 is completed first. As illustrated in FIG. 11A, the time necessary for the print preparation operation of the dryer 50 is; a+b second [s]. At the timing at which the print preparation operation of the coater 20 is completed, the print preparation operation of the dryer 50 has elapsed for a [s].

Accordingly, at the timing at which the print preparation operation of the coater 20 is completed, the degree of progress [%] of the print preparation operation of the dryer 50 can be expressed by a formula: {a/(a+b)}×100 [%]. When the degree of progress [%] is 90% or greater, it can be said that the timing at which the dryer 50 completes the print preparation operation and the timing at which the coater 20 completes the print preparation operation coincide with each other.

FIG. 11B is a diagram illustrating a case in which the print preparation operation of the dryer 50 is completed first. As illustrated in FIG. 11B, the time necessary for the print preparation operation of the coater 20 is expressed by a formula: c+d [s]. At the timing at which the dryer 50 completes the print preparation operation, the print preparation operation of the coater 20 has elapsed for c [s].

Accordingly, at the timing at which the dryer 50 completes the print preparation operation, the degree of progress [%] of the print preparation operation of the coater 20 is expressed by a formula: {c/(c+d)}×100 [%]. When the degree of progress [%] is 90% or greater, it can be said that the timing at which the dryer 50 completes the print preparation operation and the timing at which the coater 20 completes the print preparation operation coincide with each other.

As described above, the case in which the time lag between the timing at which the dryer 50 completes the print preparation operation and the timing at which the coater 20 completes the print preparation operation is within +10 seconds may correspond to the “matching of the timings” in embodiments of the present disclosure.

In this case, either the print preparation operation of the coater 20 or the print preparation operation of the dryer 50 may be completed first. When the print preparation operation of the dryer 50 is completed within +10 seconds, when the timing at which the coater 20 completes the print preparation operation is set as the reference timing (0 second), it can be said that the timing at which the dryer 50 completes the print preparation operation and the timing at which the coater 20 completes the print preparation operation coincide with each other.

Preferably, the timing at which the dryer 50 completes the print preparation operation is equal to or greater than −3 seconds or smaller than +10 seconds, when the timing at which the coater 20 completes the print preparation operation is set as the reference timing (0 second). Such a setting as described above can also prevent unnecessary heating corresponding to the time of conveying the sheet P from the coater 20 to the dryer 50.

In other words, it can be said that the time lag between the timing at which the dryer 50 completes the print preparation operation and the timing at which the coater 20 completes the print preparation operation is equal to or greater than −3 seconds or smaller than +10 seconds.

The description of the case in which the timings at which the print preparation operations are completed coincide with each other as illustrated in, for example, FIGS. 11A and 11B can be applied to the case in which the timings at which the print preparation operations of the image formers 30 coincide with each other.

As described above, in the image forming system of the present disclosure, preferably that the timing at which the image former 30 starts the print preparation operation is changed such that the timing at which the dryer 50 completes the print preparation operation and the timing at which the image former 30 completes the print preparation operation coincide with each other.

The “matching of the timings” in embodiments of the present disclosure is not limited to a perfect matching of the timings, and may include a slight margin. For example, the cases illustrated in FIGS. 11A and 11B, for example, can be included in the “matching of the timings”.

In other words, a case in which the time of one of the print preparation operations performed by dryer 50 and image former 30 to the completion elapses 90% or greater at a timing at which any of the print preparation operations is completed earlier than the other one, between the timing at which the dryer 50 completes the print preparation operation and the timing at which the coater 20 completes the print preparation operation. Such a case also is included in the “matching of the timings”.

In addition, the case in which the time lag between the timing at which the dryer 50 completes the print preparation operation and the timing at which the image former 30 completes the print preparation operation is within +10 seconds or −3 seconds or greater and equal to or less than +10 seconds may be included in the “matching of the timings”.

As described above, the image forming system of the present embodiment can minimize the time required for the printing preparation operation in the entire image forming system, and prevent damage to the recording medium due to excessive preheating of the dryer 50 in the printing preparation operation.

Aspects of the present invention are, for example, as follows.

### First Aspect

An image forming system includes a coater to coat a recording medium with a treatment liquid, an image former to form an image on the recording medium; a dryer to dry the recording medium; and circuitry to control a timing at which the coater, the image former, and the dryer start and complete a print preparation operation before a print operation is started. The coater includes a supply pan to hold the treatment liquid, a heater to heat the treatment liquid held in the supply pan, and a liquid temperature detector to detect the temperature of the treatment liquid held in the supply pan. The circuitry changes a timing at which the drier starts the print preparation operation in accordance with a detection result of the liquid temperature detector of the coater, and matches a timing at which the drier completes the print preparation operation and a timing at which the coater completes the print preparation operation.

### Second Aspect

In the image forming system according to the first aspect, the circuitry further controls the coater and the dryer to complete 90% or greater of one of the first preparation operation and the second preparation operation at the first completion timing or the second completion timing of another of the first preparation operation and the second preparation operation to match the second completion timing with the first completion timing.

### Third Aspect

In the image forming system according to the first aspect, the circuitry further controls the coater and the dryer to control a time lag between the first completion timing and the second completion timing to be within +10 seconds to match the second completion timing with the first completion timing.

### Fourth Aspect

In the image forming system according to any one of the first to third aspects, the circuitry estimates a time period for the coater to complete the print preparation operation based on a temperature of the treatment liquid detected by the liquid temperature detector, determine a timing at which the dryer starts the print preparation operation based on the time period.

### Fifth Aspect

In the image forming system according to any one of the first to third aspect, the dryer includes a heater to heat the recording medium, and a temperature measuring device to measure a temperature inside the dryer. The circuitry changes a timing at which the image former starts the print preparation operation in accordance with a detection result of the liquid temperature detector of the dryer, and matches a timing at which the dryer completes the print preparation operation with a timing at which the image former completes the print preparation operation.

### Sixth Aspect

In the image forming system according to the fourth aspect, the dryer includes a heater to heat the recording medium, and a temperature measuring device to measure a temperature inside the dryer. The circuitry changes a timing at which the image former starts the print preparation operation in accordance with a detection result of the liquid temperature detector of the dryer, and matches a timing at which the dryer completes the print preparation operation with a timing at which the image former completes the print preparation operation.

### Seventh Aspect

In the image forming system according to any one of the first to sixth aspect, the heater of the coater is a nichrome wire heater, and the liquid temperature detector is a thermistor.

### Eighth Aspect

In the image forming system according to the fifth aspect, the heater of the dryer is an IR heater, and the temperature measuring device is a radiation thermometer.

### Ninth Aspect

In the image forming system according to the sixth aspect, the heater of the dryer is an IR heater, and the temperature measuring device is a radiation thermometer.

### Tenth Aspect

In the image forming system according to any one of the first to ninth aspects, the printing preparation operation performed by the coater is a supply operation of the treatment liquid, an operation to adjust a liquid temperature of the treatment liquid, and a cleaning operation, and the print preparation operation performed by the dryer is a preheating operation.

### Eleventh Aspect

In the image forming system according to any one of the first to tenth aspects, the image former includes a head to discharge ink onto the recording medium, and the print preparation operation performed by the image former is a cleaning operation of the head and an operation to adjust a temperature of the ink.

### Twelfth Aspect

In the image forming system according to the third aspect, a time lag between the timing at which the dryer completes the print preparation operation and the timing at which the coater completes the print preparation operation is equal to or greater than −3 seconds or equal to or smaller than +10 seconds, when the timing at which the coater completes the print preparation operation is set as a reference timing (0 second).

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An image forming system comprising:
a coater to coat a recording medium with a treatment liquid, the coater including:
a supply pan to store the treatment liquid;
a heater to heat the treatment liquid in the supply pan; and
a detector to detect a temperature of the treatment liquid in the supply pan;
an image former to form an image on the recording medium coated with the treatment liquid by the coater to perform a print operation;
a dryer to dry the recording medium on which the image is formed by the image former; and
circuitry configured to, before controlling the image former to start the print operation:
control the coater to start a first preparation operation at a first start timing so that the first preparation operation is completed at a first completion timing;
control the dryer to start a second preparation operation at a second start timing so that the second preparation operation is completed at a second completion timing; and
change the second start timing of the dryer according to the temperature of the treatment liquid detected by the detector of the coater to match the second completion timing of the dryer with the first completion timing of the coater.

2. The image forming system according to claim 1,
wherein the circuitry is further configured to match the second completion timing of the dryer with the first completion timing of the coater to complete 90% or greater of one of the first preparation operation and the second preparation operation at the first completion timing or the second completion timing of another of the first preparation operation and the second preparation operation.

3. The image forming system according to claim 1,
wherein the circuitry is further configured to match the second completion timing of the dryer with the first completion timing of the coater to control a time lag between the first completion timing and the second completion timing to be within +10 seconds.

4. The image forming system according to claim 1,
wherein the circuitry is further configured to:
estimate a time period taken by the coater to complete the first preparation operation based on the temperature of the treatment liquid detected by the detector; and
determine the second start timing of the dryer based on the time period estimated.

5. The image forming system according to claim 1,
wherein the dryer includes:
another heater to heat the recording medium; and
an another detector to detect another temperature in the dryer, and
the circuitry is further configured to control the image former and the dryer to:
change a third start timing at which the image former starts a print preparation operation according to said another temperature detected by said another detector; and
match the second completion timing with a third completion timing at which the image former completes the print preparation operation.

6. The image forming system according to claim 4,
wherein the dryer includes:
another heater to heat the recording medium; and
an another detector to detect another temperature in the dryer, and
the circuitry is further configured to control the image former and the dryer to:
change a third start timing at which the image former starts a print preparation operation according to said another temperature detected by said another detector; and
match the second completion timing with a third completion timing at which the image former completes the print preparation operation.

7. The image forming system according to claim 1,
wherein said another heater of the dryer includes an infrared heater, and
said another detector includes a radiation thermometer.

8. The image forming system according to claim 5,
wherein said another heater of the dryer includes an infrared heater, and
said another detector includes a radiation thermometer.

9. The image forming system according to claim 6,
wherein the heater of the dryer includes an infrared heater, and
said another detector includes a radiation thermometer.

10. The image forming system according to claim 1,
wherein the circuitry is further configured to:
supply the treatment liquid;
adjust the temperature of the treatment liquid; and
clean the coater,
to perform the first preparation operation; and
preheat the dryer to perform the second preparation operation.

11. The image forming system according to claim 1,
wherein the image former includes a head to discharge ink onto the recording medium, and
the circuitry is further configured to control the image former to:
clean the head; and
adjust a temperature of the ink,
to perform a print preparation operation.

12. The image forming system according to claim 3,
wherein the circuitry is configured to control the time lag between the second completion timing of the dryer and the first completion timing of the coater to be within −3 to +10 seconds,
when the first completion timing is set as a reference timing of zero seconds.
